(19) United States
(12) Patent Application Publication
(10) Pub. No.: US 2021/0158291 A1
(43) Pub. Date: May 27, 2021

(54) INFORMATION PROCESSING METHOD AND INFORMATION PROCESSING SYSTEM

(71) Applicant: Panasonic Intellectual Property Corporation of America, Torrance, CA (US)

(72) Inventors: Atsuyoshi KITA, Osaka (JP); Keisuke IWATA, Osaka (JP)

(21) Appl. No.: 17/165,209

(22) Filed: Feb. 2, 2021

Related U.S. Application Data
(63) Continuation of application No. PCT/JP2019/041703, filed on Oct. 24, 2019.
(60) Provisional application No. 62/799,992, filed on Feb. 1, 2019.

(30) Foreign Application Priority Data
Jun. 21, 2019 (JP) 2019-115342

(51) Int. Cl. G06Q 10/08; G06Q 10/04; B60L 58/16; G05D 1/02

(52) U.S. Cl. CPC G06Q 10/08355; G05D 1/0217; B60L 58/16; G06Q 10/047

(57) ABSTRACT

An information processing method executed by a computer includes: creating a delivery plan for packages to be delivered by electric-powered mobile bodies, based on a constraint on travel for each electric-powered mobile body; calculating power consumption of each electric-powered mobile body based on the delivery plan; calculating a charge amount of each electric-powered mobile body from the power consumption and a remaining amount of power; creating a charging plan for the electric-powered mobile bodies based on the charge amount of each electric-powered mobile body; determining whether charging of each electric-powered mobile body will finish by start of delivery based on the delivery plan and the charging plan; recreating the delivery plan based on a tightened constraint obtained by tightening the constraint for an electric-powered mobile body whose charging is determined not to finish by the start of delivery; and outputting the delivery plan recreated.

### CROSS REFERENCE TO RELATED APPLICATIONS

This is a continuation application of PCT International Application No. PCT/JP2019/041703 filed on Oct. 24, 2019, designating the United States of America, which is based on and claims priority of U.S. Provisional Patent Application No. 62/799,992 filed on Feb. 1, 2019 and Japanese Patent Application No. 2019-115342 filed on Jun. 21, 2019. The entire disclosures of the above-identified applications, including the specifications, drawings and claims are incorporated herein by reference in their entirety.

### FIELD

The present disclosure relates to an information processing method and an information processing system.

### BACKGROUND

A method of creating a charging plan for an electric vehicle has been proposed (for example, see Patent Literature (PTL) 1) conventionally.

### CITATION LIST

### Patent Literature

PTL 1: Japanese Unexamined Patent Application Publication No. 2018-64413

### SUMMARY

### Technical Problem

However, in PTL 1, only a charging plan is output. This may lead to inconsistency between the delivery plan for packages to be delivered by an electric-powered mobile body, such as an electric vehicle, and the charging plan that is output.

One non-limiting and exemplary embodiment of the present disclosure provides an information processing method and an information processing system that enable creation of a delivery plan consistent with a charging plan.

### Solution to Problem

In one general aspect, the techniques disclosed here feature an information processing method executed by a computer including: creating a delivery plan for packages to be delivered by a plurality of electric-powered mobile bodies, based on a constraint on travel for each of the plurality of electric-powered mobile bodies; calculating power consumption of each of the plurality of electric-powered mobile bodies based on the delivery plan; calculating a charge amount of each of the plurality of electric-powered mobile bodies from the power consumption and a remaining amount of power; creating a charging plan for the plurality of electric-powered mobile bodies based on the charge amount of each of the plurality of electric-powered mobile bodies; determining whether charging of each of the plurality of electric-powered mobile bodies will finish by start of delivery, based on the delivery plan and the charging plan; recreating the delivery plan based on a tightened constraint that is obtained by tightening the constraint for an electric-powered mobile body whose charging is determined not to finish by the start of delivery; and outputting the delivery plan recreated.

In one general aspect, the techniques disclosed here feature an information processing system including: a delivery plan creator that creates a delivery plan for packages to be delivered by a plurality of electric-powered mobile bodies, based on a constraint on travel for each of the plurality of electric-powered mobile bodies; a power consumption calculator that calculates power consumption of each of the plurality of electric-powered mobile bodies based on the delivery plan; a charge amount calculator that calculates a charge amount of each of the plurality of electric-powered mobile bodies from the power consumption and a remaining amount of power; a charging plan creator that creates a charging plan for the plurality of electric-powered mobile bodies based on the charge amount of each of the plurality of electric-powered mobile bodies; a determiner that determines whether charging of each of the plurality of electric-powered mobile bodies will finish by start of delivery, based on the delivery plan and the charging plan; and an outputter that outputs the delivery plan created. The delivery plan creator recreates the delivery plan based on a tightened constraint that is obtained by tightening the constraint for an electric-powered mobile body whose charging is determined not to finish by the start of delivery.

### Advantageous Effects

The information processing method and the information processing system according to one aspect of the present disclosure enable creation of a delivery plan that is consistent with the charging plan.

### BRIEF DESCRIPTION OF DRAWINGS

These and other advantages and features will become apparent from the following description thereof taken in conjunction with the accompanying Drawings, by way of non-limiting examples of embodiments disclosed herein.

FIG. 1 is a block diagram of a configuration of an information processing system according to an embodiment.

FIG. 2 is a flowchart of a first delivery plan creation process according to the embodiment.

FIG. 3 is a flowchart of a second delivery plan creation process according to a variation.

### DESCRIPTION OF EMBODIMENT

### (Underlying Knowledge Forming Basis of the Present Disclosure)

In relation to the method of creating a charging plan for an electric vehicle disclosed in the Background section, the inventors have found the following problem: when a delivery plan for packages to be delivered by electric-powered mobile bodies, such as electric vehicles, is created by applying the conventional method of creating a charging plan to electric-powered mobile bodies that are scheduled to be operated in the delivery plan, the delivery plan may not be implemented. For example, there may be an electric-powered mobile body whose charging will not finish by start of delivery. Furthermore, for example, if the charging completion time is too earlier than the start of delivery, storage degradation may increase depending on the charge amount. In view of the above, the inventors have enthusiastically examined and experimented with a method of creating a delivery plan consistent with a charging plan. As a result, the inventors have conceived the following information processing method and information processing system.

An information processing method according to one aspect of the present disclosure is an information processing method executed by a computer including: creating a delivery plan for packages to be delivered by a plurality of electric-powered mobile bodies, based on a constraint on travel for each of the plurality of electric-powered mobile bodies; calculating power consumption of each of the plurality of electric-powered mobile bodies based on the delivery plan; calculating a charge amount of each of the plurality of electric-powered mobile bodies from the power consumption and a remaining amount of power; creating a charging plan for the plurality of electric-powered mobile bodies based on the charge amount of each of the plurality of electric-powered mobile bodies; determining whether charging of each of the plurality of electric-powered mobile bodies will finish by start of delivery, based on the delivery plan and the charging plan; recreating the delivery plan based on a tightened constraint that is obtained by tightening the constraint for an electric-powered mobile body whose charging is determined not to finish by the start of delivery; and outputting the delivery plan recreated.

With the information processing method, when charging of an electric-powered mobile body is determined not to finish by the start of delivery in the created delivery plan, the delivery plan is recreated based on a tightened constraint that is obtained by tightening the constraint for the electric-powered mobile body. The information processing method described above enables creation of a delivery plan that is consistent with the charging plan.

For example, in the information processing method, the constraint may be an upper bound on a travel distance, and the recreating of the delivery plan may include lowering the upper bound on the travel distance for the electric-powered mobile body whose charging is determined not to finish by the start of delivery. In this way, it is possible to control recreation of the delivery plan using an upper bound on the travel distance. For example, when charging of an electric-powered mobile body is determined not to finish by the start of delivery in the created delivery plan, the delivery plan can be recreated to shorten the travel distance of such an electric-powered mobile body.

Moreover, the information processing method may include: obtaining a degree of battery degradation of each of the plurality of electric-powered mobile bodies; calculating a usable amount of power for each of the plurality of electric-powered mobile bodies, based on a battery charge amount that falls within a range of a predetermined degree of degradation acceleration obtained from the degree of battery degradation; and calculating the constraint for each of the plurality of electric-powered mobile bodies based on the usable amount of power. In this way, it is possible to create a delivery plan that suppresses the battery degradation.

Moreover, in the information processing method, the recreating of the delivery plan may further include, when charging of an electric-powered mobile body is determined not to finish by the start of delivery, easing the constraint for the electric-powered mobile body whose charging is determined not to finish by the start of delivery. In this way, it is possible to create a delivery plan that is more consistent with the charging plan.

Moreover, in the information processing method, the recreating of the delivery plan may include: determining whether the remaining amount of power will decrease below a predetermined threshold for each of the plurality of electric-powered mobile bodies; and tightening the constraint for an electric-powered mobile body having a remaining amount of power that is determined to decrease below the predetermined threshold. In this way, it is possible to create a delivery plan that prevents electric-powered mobile bodies from running out of power during delivery.

Moreover, in the information processing method, the charging plan may include suppressing the battery degradation. In this way, it is possible to suppress the battery degradation.

An Information processing system according to one aspect of the present disclosure includes: a delivery plan creator that creates a delivery plan for packages to be delivered by a plurality of electric-powered mobile bodies, based on a constraint on travel for each of the plurality of electric-powered mobile bodies; a power consumption calculator that calculates power consumption of each of the plurality of electric-powered mobile bodies based on the delivery plan; a charge amount calculator that calculates a charge amount of each of the plurality of electric-powered mobile bodies from the power consumption and a remaining amount of power; a charging plan creator that creates a charging plan for the plurality of electric-powered mobile bodies based on the charge amount of each of the plurality of electric-powered mobile bodies; a determiner that determines whether charging of each of the plurality of electric-powered mobile bodies will finish by start of delivery, based on the delivery plan and the charging plan; and an outputter that outputs the delivery plan created. The delivery plan creator recreates the delivery plan based on a tightened constraint that is obtained by tightening the constraint for an electric-powered mobile body whose charging is determined not to finish by the start of delivery.

With the above information processing system, when charging of an electric-powered mobile body is determined not to finish by the start of delivery in the created delivery plan, the delivery plan is recreated based on a tightened constraint that is obtained by tightening the constraint for the electric-powered mobile body. Accordingly, the information processing system described above enables creation of a delivery plan that is consistent with the charging plan.

Hereinafter, the information processing method and the information processing system according to one or more aspects of the present disclosure are described in greater detail with reference to the accompanying Drawings. Note that each embodiment described below shows a general or specific example of the present disclosure. Therefore, the numerical values, shapes, materials, elements, the arrangement and connection of the elements, steps, the processing order of the steps etc. shown in the following exemplary embodiment are mere examples, and therefore do not limit the scope of the present disclosure. Each figure is a schematic diagram and is not necessarily precise illustration.

Note that these general or specific aspects disclosed above may be implemented using a system, a method, an integrated circuit, a computer program, or a computer-readable recording medium such as a CD-ROM, or any combination of systems, methods, integrated circuits, computer programs, or computer-readable recording media.

### Embodiment 1

The following describes an information processing system according to an embodiment. The information processing system creates a delivery plan for packages to be delivered by electric-powered mobile bodies. The delivery plan is consistent with a charging plan.

Here, as an example, the electric-powered mobile body is described as a battery-driven self-driving vehicle, but the electric-powered mobile body does not necessarily need to be limited to such a battery-driven self-driving vehicle as long as the electric-powered mobile body is capable of delivering a package. The electric-powered mobile body may be, for example, an autonomous flying or remote-control drone, or a vehicle manually driven by a driver on board.

### [1. Configuration of Information Processing System]

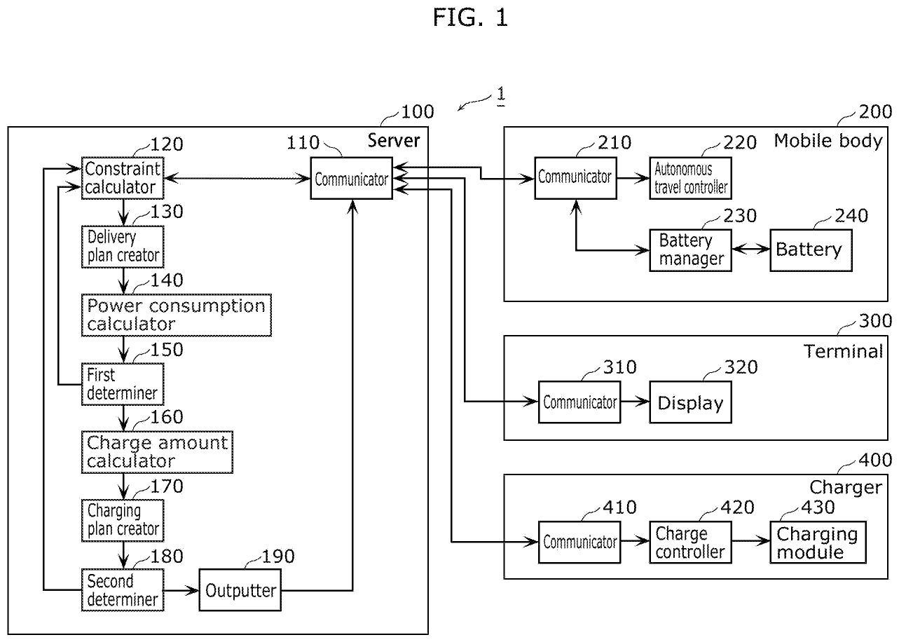

FIG. 1 is a block diagram of a configuration of information processing system 1 according to an embodiment.

As illustrated in FIG. 1, information processing system 1 includes server 100, mobile body 200, terminal 300, and charger 400. FIG. 1 illustrates as if information processing system 1 includes one mobile body 200. However, information processing system 1 includes a plurality of mobile bodies 200 in practice. FIG. 1 also illustrates as if information processing system 1 includes one terminal 300. However, in practice, information processing system 1 may include one terminal 300, a plurality of terminals 300, or no terminal 300. FIG. 1 also illustrates as if information processing system 1 includes one charger 400. However, in practice, information processing system 1 may include one charger 400 or a plurality of chargers 400.

Each mobile body 200 is an electric-powered mobile body. Mobile body 200 includes communicator 210, autonomous travel controller 220, battery manager 230, and battery 240.

Battery 240 is a secondary battery that supplies power to an electric-powered driving device (e.g., a motor, not illustrated) that drives mobile body 200. Battery 240 is charged by charger 400. Charger 400 is attachable to and detachable from battery 240.

Battery manager 230 manages a state of battery 240. More specifically, battery manager 230 manages a current state of charge (SOC, the remaining amount of power) of battery 240 and a current state of health (SOH, a degree of battery degradation) of battery 240.

Communicator 210 communicates with other devices that can establish communication with communicator 210. Examples of the other devices include server 100. Communicator 210 receives, for example, a delivery plan (discussed below) transmitted from server 100. In addition, communicator 210 transmits the SOC and SOH managed by battery manager 230 to server 100 in response to a request from server 100, for example. Communicator 210 may include, for example, a wireless communication device, and may communicate with other devices wirelessly.

Autonomous travel controller 220 controls autonomous traveling of mobile body 200. For example, when a delivery plan is received by communicator 210, autonomous travel controller 220 controls the autonomous traveling of mobile body 200 according to the delivery plan. Autonomous travel controller 220 may be implemented as, for example, dedicated hardware, or may also be implemented by, for example, including a processor and a memory and executing a program stored in the memory by the processor.

Note that, as described above, mobile body 200 may be a mobile body manually operated by a driver on board. In this case, mobile body 200 may include, for example, a steerer for manually steering mobile body 200 and a display that displays the contents of the delivery plan transmitted from server 100, instead of autonomous travel controller 220. In this case, the driver operates the steerer according to the contents of the delivery plan displayed on the display to operate mobile body 200, and causes mobile body 200 to travel according to the delivery plan.

Terminal 300 is a terminal owned by a user who uses information processing system 1. Terminal 300 includes communicator 310 and display 320.

Communicator 310 communicates with other devices that can establish communication with communicator 310. Other devices include server 100. Communicator 310 receives, for example, a delivery plan and a charging plan (discussed below) transmitted from server 100. Communicator 310 may include, for example, a wireless communication device, and may communicate with other devices wirelessly.

Display 320 displays an image to the user who uses terminal 300. Display 320 displays, for example, an image indicating the contents of the delivery plan or the charging plan when the delivery plan or the charging plan is received by communicator 310. Display 320 may include, for example, a display device such as a liquid crystal display, and display an image on the display device.

Charger 400 charges battery 240. Charger 400 includes communicator 410, charge controller 420, and charging module 430.

Charging module 430 includes a charging circuit that is detachably attached to battery 240. Charging module 430 charges battery 240.

Communicator 410 communicates with other devices that can establish communication with communicator 410. Other devices include server 100. Communicator 410 receives, for example, a charging plan transmitted from server 100. Communicator 410 may include, for example, a wireless communication device, and may communicate with other devices wirelessly.

Charge controller 420 controls charging of battery 240 performed by charging module 430. For example, when a charging plan is received by communicator 410, charge controller 420 controls the charging of battery 240 performed by charging module 430 according to the charging plan. Charge controller 420 may be implemented as, for example, dedicated hardware, or may be implemented, for example, by including a processor and memory and executing a program stored in memory by the processor.

Server 100 is used by a management company (for example, a courier company) that operates information processing system 1. Server 100 includes communicator 110, constraint calculator 120, delivery plan creator 130, power consumption calculator 140, first determiner 150, charge amount calculator 160, charging plan creator 170, second determiner 180, and outputter 190. Server 100 is, for example, a computer including a processor and a memory, and various functions may be implemented by executing a program stored in the memory by the processor.

Communicator 110 communicates with other devices that can establish communication with communicator 110. Other devices include mobile body 200, terminal 300, and charger 400. Communicator 110 transmits, to each mobile body 200, a request indicating a request for transmission of SOC and SOH, for example. Communicator 110 receives, for example, the SOC and SOH transmitted from each mobile body 200 in response to the request transmitted by communicator 110. For example, when a delivery plan is output from outputter 190, communicator 110 transmits the delivery plan to each mobile body 200 and each terminal 300. For example, when a charging plan is output from outputter 190, communicator 110 transmits the charging plan to each terminal 300 and each charger 400. For example, communicator 110 receives, from another server (not illustrated), a delivery list of packages to be delivered. The server is an external device.

Constraint calculator 120 calculates a constraint on travel for each of mobile bodies 200. For example, constraint calculator 120 may calculate a charge amount at which the degradation of battery 240 is suppressed for each of mobile bodies 200, and calculate a constraint from the calculated charge amount. More specifically, for example, constraint calculator 120 may obtain a current SOH, which is a degree of degradation of battery 240 received by communicator 110 for each of mobile bodies 200; calculate a usable amount of power based on a battery charge amount within a predetermined range of the degree of degradation acceleration (for example, within 0.01%) obtained from the current SOH that is obtained; and calculate a constraint based on the calculated usable amount of power. Here, constraint calculator 120 may calculate, for example, an upper bound on a travel distance as a constraint based on the usable amount of power and an average fuel economy. In addition, constraint calculator 120 calculates, for example, the charge amount obtained by adding a fixed value of the charge amount to the current SOH received by communicator 110 for each of mobile bodies 200, and calculate, as a constraint, the upper bound on travel distance based on the calculated charge amount and the average fuel economy. Furthermore, constraint calculator 120 may calculate, for example, an upper bound on a time period from the start to end of travel for each mobile body 200 as a constraint. Furthermore, constraint calculator 120 may calculate, for example, an upper bound on the amount of power consumption from the start to the end of travel for each mobile body 200 as a constraint. Furthermore, constraint calculator 120 may calculate a constraint by, for example, any combination of the above.

Delivery plan creator 130 creates a delivery plan for packages to be delivered by mobile bodies 200 (assignment of packages for each mobile body 200, a delivery route for each mobile body 200, an unassigned package list, etc.) based on the constraint on travel of each mobile body 200 calculated by constraint calculator 120. Delivery plan creator 130 may further create a delivery plan based on, for example, the delivery list received by communicator 110 and a mobile body list of mobile bodies 200 stored in advance. Delivery plan creator 130 may, for example, create a delivery plan to minimize a total travel distance of mobile bodies 200. Delivery plan creator 130 may, for example, create a delivery plan to minimize a total degradation amount of batteries 240 of mobile bodies 200. Delivery plan creator 130 may, for example, create a delivery plan to minimize total power consumption of mobile bodies 200. Delivery plan creator 130 may, for example, create a delivery plan to minimize a total amount of time required for delivery to be performed by mobile bodies 200. Delivery plan creator 130 may, for example, create a delivery plan using any combination of the above.

In addition, for example, delivery plan creator 130 may create a delivery plan to leave a backup amount of power to reduce a possibility that mobile body 200 will run out of power during delivery. Furthermore, delivery plan creator 130 may create a delivery plan by considering that the travel distance may be extended when mobile body 200 uses regenerative power, for example.

Power consumption calculator 140 calculates power consumption of each of mobile bodies 200 based on the delivery plan created by delivery plan creator 130.

First determiner 150 determines whether the remaining amount of power will decrease below a predetermined threshold for each of mobile bodies 200. More specifically, first determiner 150 calculates the remaining amount of power from the calculated power consumption and the amount of power before travel. First determiner 150 compares the calculated remaining amount of power with the predetermined threshold to determine whether each of mobile bodies 200 will run out of power. Here, the predetermined threshold may be, for example, the amount of power at which mobile body 200 runs out of power.

First determiner 150 causes constraint calculator 120 to tighten the constraint for each mobile body 200 having a remaining amount of power that is determined to decrease below the predetermined threshold, and to recalculate the constraint on travel for each of mobile bodies. In this case, for example, first determiner 150 may further cause constraint calculator 120 to ease the constraint for each of mobile bodies 200 having a remaining amount of power that is determined not to decrease below the predetermined threshold, and to recalculate the constraint for each of mobile bodies 200.

First determiner 150 may, for example, perform the above determination by considering a backup amount of power in order to reduce a possibility that mobile body 200 will run out of power during delivery. For example, first determiner 150 may perform the above determination by considering that the travel distance may be extended by using the regenerative power of mobile body 200.

Charge amount calculator 160 calculates the charge amount from the power consumption and the remaining amount of power calculated by power consumption calculator 140 for each of mobile bodies 200. Charge amount calculator 160 may calculate the charge amount of each of mobile bodies 200 to suppress the degradation of battery 240 due to overcharge or overdischarge. For example, charge amount calculator 160 may calculate, as the charge amount of each of mobile bodies 200, a value obtained by adding the power consumption amount determined based on the delivery plan to a minimum usable charge amount (for example, 20%). Charge amount calculator 160 may calculate, as the charge amount of each of mobile bodies 200, for example, a value obtained by adding half the value of the power consumption amount determined based on the delivery plan to a central charge amount (for example, 50%).

Charging plan creator 170 creates a charging plan for mobile bodies 200 (a target SOC for each battery 240, the charge start time and the charge end time of each battery 240) based on the charge amount of each of mobile bodies 200 calculated by charge amount calculator 160. Here, the charging plan to be created by charging plan creator 170 may include, for example, a charging plan that suppresses degradation of batteries 240. More specifically, charging plan creator 170 may, for example, create a charging plan to minimize degradation of batteries 240 of mobile bodies 200.

Second determiner 180 determines whether charging of mobile bodies 200 will finish by the start of delivery, based on the delivery plan created by delivery plan creator 130 and the charging plan created by charging plan creator 170.

Second determiner 180 causes constraint calculator 120 to tighten the constraint for mobile body 200 whose charging is determined not to finish by the start of delivery, and recalculates the respective constraints on travel for all of mobile bodies 200. In this case, for example, second determiner 180 may calculate a shortage charge amount for each mobile body 200 whose charging is determined not to finish by the start of delivery. Then, second determiner 180 may cause constraint calculator 120 to tighten the constraint according to the shortage charge amount for each mobile body 200 whose charging is determined not to finish by the start of delivery and to recalculate the respective constraints on travel for all of mobile bodies 200. When the constraint is an upper bound on the travel distance, second determiner 180 may cause constraint calculator 120 to lower the upper bound on the travel distance for each mobile body 200 whose charging is determined not to finish by the start of delivery. Moreover, for example, second determiner 180 may ease the constraint for mobile body 200 whose charging is determined to finish by the start of delivery, and recalculate constraint on travel for each of mobile bodies 200.

Outputter 190 outputs the delivery plan created by delivery plan creator 130 and the charging plan created by charging plan creator 170 to communicator 110, when second determiner 180 determines that charging of mobile bodies 200 will finish by the start of delivery.

### [2. Operations of Information Processing System]

Information processing system 1 having the above configuration performs a first delivery plan creation process for creating a delivery plan for packages to be delivered by mobile bodies 200.

The following describes an example of the first delivery plan creation process performed by information processing system 1 with reference to the Drawings.

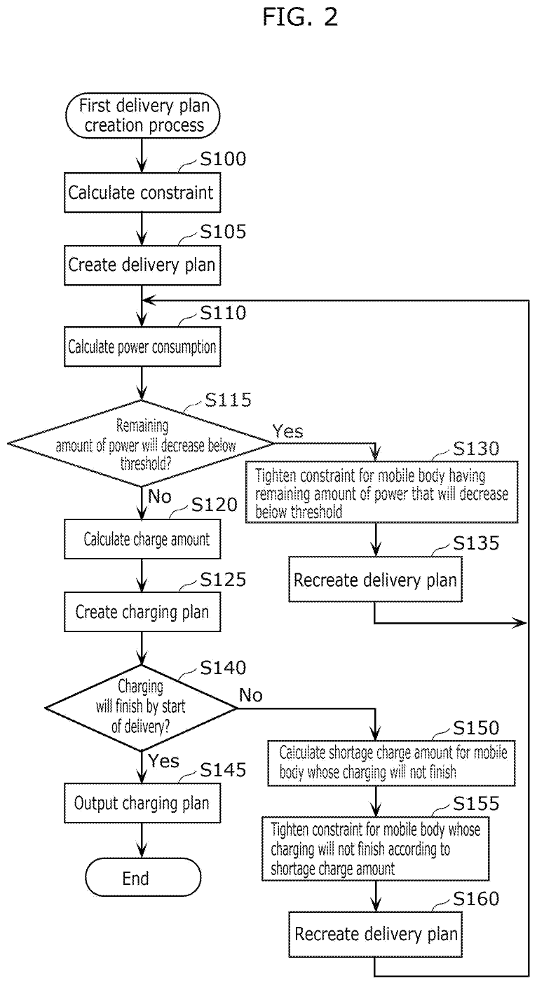

FIG. 2 is a flowchart of the first delivery plan creation process.

The first delivery plan creation process is started, for example, by a user who uses information processing system 1 performing an operation on server 100 to start the first delivery plan creation process.

When the first delivery plan creation process is started, communicator 110 transmits, to each mobile body 200, a request for transmission of a current SOC and a current SOH of battery 240. Communicator 110 receives a current SOC and a current SOH of battery 240 from each mobile body 200.

After communicator 110 receives the current SOC and the current SOH of battery 240 from each mobile body 200, constraint calculator 120 calculates a constraint on travel for each of mobile bodies 200 (step S100). More specifically, constraint calculator 120 calculates a usable amount of power for each mobile body 200 based on a battery charge amount that falls within a predetermined range of the degree of degradation acceleration obtained from the current SOH of battery 240 received by communicator 110. Constraint calculator 120 calculates, as a constraint, an upper bound on travel distance from the calculated usable amount of power for each mobile body 200.

After constraint calculator 120 calculates a constraint, delivery plan creator 130 creates a delivery plan for packages to be delivered by mobile bodies 200, based on the calculated constraint on travel for each of mobile bodies 200 (step S105). More specifically, delivery plan creator 130 creates a delivery plan to minimize a total travel distance of mobile bodies 200 within a range in which the constraint is satisfied.

After delivery plan creator 130 creates a delivery plan, power consumption calculator 140 calculates power consumption of each of mobile bodies 200 based on the created delivery plan (step S110).

After power consumption calculator 140 calculates the power consumption for each of mobile bodies 200, first determiner 150 determines whether the remaining amount of power will decrease below a predetermined threshold for each of mobile bodies 200 (step S115). Here, the predetermined threshold is, more specifically, the amount of power at which mobile body 200 runs out of power.

When one or more mobile bodies 200 have a remaining amount of power that is determined to decrease below the predetermined threshold in the processing in step S115 (Yes in step S115), constraint calculator 120 tightens the constraint for each mobile body 200 having a remaining amount of power that is determined to decrease below the predetermined threshold, and to recalculate the respective constraints on travel for all of mobile bodies 200 (step S130).

After constraint calculator 120 recalculates the constraint, delivery plan creator 130 recreates the delivery plan for packages to be delivered by mobile bodies 200 based on the recalculated constraint on travel for each mobile body 200 (step S135). When the processing in step S135 ends, the first delivery plan creation process proceeds to the processing in step S110 again.

When no mobile body 200 has a remaining amount of power that is determined to decrease below the predetermined threshold in the processing in step S115 (No in step S115), charge amount calculator 160 calculates the charge amount from the power consumption and the remaining amount of power calculated by power consumption calculator 140 for each of mobile bodies 200 (step S120).

After charge amount calculator 160 calculates the charge amount, charging plan creator 170 creates a charging plan for mobile bodies 200 based on the charge amount of each mobile body 200 (step S125). More specifically, charging plan creator 170 creates a charging plan to minimize degradation of respective batteries 240 of mobile bodies 200.

After charging plan creator 170 creates the charging plan, second determiner 180 determines whether charging of mobile bodies 200 will finish by the start of delivery, based on the delivery plan created by delivery plan creator 130 and the charging plan created by charging plan creator 170 (step S140).

When charging of mobile bodies 200 is determined not to finish by the start of delivery in the processing of step S140, i.e., charging of one or more mobile bodies 200 is determined not to finish by the start of delivery (No in step S140), second determiner 180 calculates a shortage charge amount for each of mobile bodies 200 whose charging is determined not to finish by the start of delivery (step S150).

After second determiner 180 calculates the shortage charge amount for each of mobile bodies 200 whose charging is determined not to finish by the start of delivery, constraint calculator 120 tightens the constraint for each mobile body 200 whose charging is determined not to finish by the start of delivery according to the shortage charge amount, and recalculates the respective constraints on travel for all of mobile bodies 200 (step S155).

After constraint calculator 120 recalculates the constraints, delivery plan creator 130 recreates the delivery plan for packages to be delivered by mobile bodies 200, based on the recalculated constraint on travel for each mobile body 200 (step S160). When the processing in step S160 ends, the first delivery plan creation process proceeds to the processing in step S110 again.

When charging of mobile bodies 200 is determined to finish by the start of delivery in the processing of step S140, i.e., charging of all of mobile bodies 200 is determined to finish by the start of delivery (Yes in step S140), outputter 190 outputs, to communicator 110, the delivery plan created by delivery plan creator 130 and the charging plan created by charging plan creator 170 (step S145).

When the processing in step S145 ends, information processing system 1 ends the first delivery plan creation process.

### [3. Discussion]

Information processing system 1 having the above configuration recreates the delivery plan based on a tightened constraint that is obtained by tightening the constraint for each mobile body 200 whose charging will not finish by the start of delivery, when charging of one or more mobile bodies 200 in the created delivery plan is determined to not to finish by the start of delivery. Therefore, information processing system 1 having the above configuration enables creation of a delivery plan that is consistent with a charging plan.

### Supplement

Although the information processing system according to one aspect of the present disclosure has been described thus far based on an exemplary embodiment, the present disclosure is not limited to such embodiment. Various modifications of the present embodiment as well as embodiments resulting from combinations of elements of a different embodiment that may be conceived by those skilled in the art may be included within the scope of the one or more aspects of the present disclosure as long as these do not depart from the teachings of the present disclosure.

(1) In the above embodiment, information processing system 1 has been described to perform the first delivery plan creation process as a process of creating a delivery plan for packages to be delivered by mobile bodies 200. In this respect, information processing system 1 may perform a second delivery plan creation process as a process of creating a delivery plan for packages to be delivered by mobile bodies 200, instead of the first delivery plan creation process.

The following describes the second delivery plan creation process with reference to the Drawings.

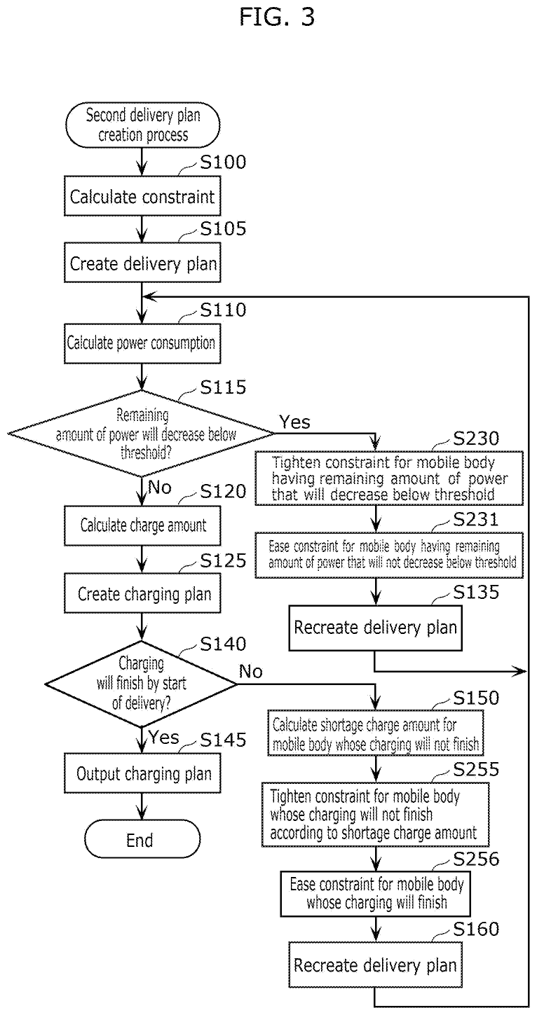

FIG. 3 is a flowchart of the second delivery plan creation process.

As illustrated in FIG. 3, the second delivery plan creation process differs from the first delivery plan creation process according to the embodiment in the following points: step S130 is renamed step S230; step S231 is added; step S155 is renamed step S255; and step S256 is added. Therefore, the processing performed from step S230 to step S231, and the processing performed from step S255 to step S256 are mainly discussed here.

When one or more mobile bodies 200 have a remaining amount of power that is determined to decrease below the predetermined threshold in the processing in step S115 (Yes in step S115), constraint calculator 120 tightens the constraint for each mobile body 200 having a remaining amount of power that is determined to decrease below the predetermined threshold (step S230), eases the constraint for each mobile body 200 having a remaining amount of power that is determined not to decrease below the predetermined threshold, and recalculates the respective constraints on travel for all of mobile bodies 200 (step S231).

When the processing in step S231 ends, the second delivery plan creation process proceeds to the processing in step S135 again.

When the processing in step S150 ends, constraint calculator 120 tightens the constraint for each mobile body 200 whose charging is determined not to finish by the start of delivery according to a shortage charge amount (step S255). Constraint calculator 120 further eases the constraint for each mobile body 200 whose charging is determined to finish by the start of delivery, and recalculates the respective constraints on travel for all of mobile bodies 200 (step S256).

When the processing in step S231 ends, the second delivery plan creation process proceeds to the processing in step S160.

(2) Information processing system 1 may output the constraint when the delivery plan creation process ends successfully. More specifically, after the processing by second determiner 180 is performed, outputter 190 outputs the constraint when outputter 190 outputs the delivery plan and the charging plan. The constraint that is output is transmitted to an external device, such as terminal 300, via communicator 110. The constraint is output by an output device, such as display 320. The constraint that is to be output is an updated constraint, i.e., a recalculated constraint. For example, the constraint is output by outputter 190 in step S145 in FIG. 2.

Accordingly, outputting an updated constraint increases the possibility that an initial value of constraint in subsequent delivery plan creation processes will be a value close to a value suitable for the delivery plan creation. This makes it possible to reduce the processing amount.

(3) Part or all of the elements included in information processing system 1 may be implemented as a single system large scale integration (LSI). For example, the system LSI is a super-multifunctional LSI produced by integrating a plurality of structural portions onto a single chip and, more specifically, is a computer system including a microprocessor, a read-only memory (ROM), a random-access memory (RAM), etc. The ROM stores a computer program. The microprocessor performs operations according to the computer program. With this, the system LSI achieves its function.

Note that the term system LSI has been used as an example, but it may be referred to as an integrated circuit (IC), an LSI, a super LSI, and an ultra LSI depending on the degree of integration. Moreover, the method of circuit integration is not limited to LSI. Integration may be implemented with a dedicated circuit or a general purpose processor. A field-programmable gate array (FPGA) or a reconfigurable processor that allows reconfiguration of the connection or configuration of the inner circuit cells of the LSI circuit after production of the LSI may be used.

Furthermore, when advancement in semiconductor technology or derivatives of other technologies brings forth a circuit integration technology that replaces LSI, it will be appreciated that such a circuit integration technology may be used to integrate functional blocks. Adaption of biotechnology, for example, is a possibility.

(4) One or more aspects of the present disclosure are not limited to such an information processing system, and thus may be an information processing method that includes as its steps the characteristic components of the information processing system. One or more aspects of the present disclosure may also be implemented as a computer program to cause a computer to execute each characteristic step included in the information processing method. One or more aspects of the present disclosure may also be a non-transitory, computer-readable recording medium on which such a computer program is stored.

The herein disclosed subject matter is to be considered descriptive and illustrative only, and the appended Claims are of a scope intended to cover and encompass not only the particular embodiment disclosed, but also equivalent structures, methods, and/or uses.

### INDUSTRIAL APPLICABILITY

The information processing method and the information processing system according to one or more aspects disclosed herein are widely applicable to devices that create a delivery plan for packages, for example.

1. An information processing method executed by a computer, the information processing method comprising:
creating a delivery plan for packages to be delivered by a plurality of electric-powered mobile bodies, based on a constraint on travel for each of the plurality of electric-powered mobile bodies;
calculating power consumption of each of the plurality of electric-powered mobile bodies based on the delivery plan;
calculating a charge amount of each of the plurality of electric-powered mobile bodies from the power consumption and a remaining amount of power;
creating a charging plan for the plurality of electric-powered mobile bodies based on the charge amount of each of the plurality of electric-powered mobile bodies;
determining whether charging of each of the plurality of electric-powered mobile bodies will finish by start of delivery, based on the delivery plan and the charging plan;
recreating the delivery plan based on a tightened constraint that is obtained by tightening the constraint for an electric-powered mobile body whose charging is determined not to finish by the start of delivery;
outputting the delivery plan recreated;
obtaining a degree of battery degradation of each of the plurality of electric-powered mobile bodies;
calculating a usable amount of power for each of the plurality of electric-powered mobile bodies, based on a battery charge amount that falls within a range of a predetermined degree of degradation acceleration obtained from the degree of battery degradation; and
calculating the constraint for each of the plurality of electric-powered mobile bodies based on the usable amount of power.

2. The information processing method according to claim 1, wherein
the constraint is an upper bound on a travel distance, and
the recreating of the delivery plan includes lowering the upper bound on the travel distance for the electric-powered mobile body whose charging is determined not to finish by the start of delivery.

3. The information processing method according to claim 1, wherein
the recreating of the delivery plan further includes, when charging of an electric-powered mobile body is determined not to finish by the start of delivery, easing the constraint for the electric-powered mobile body whose charging is determined not to finish by the start of delivery.

4. The information processing method according to claim 1, wherein
the recreating of the delivery plan includes:
determining whether the remaining amount of power will decrease below a predetermined threshold for each of the plurality of electric-powered mobile bodies; and
tightening the constraint for an electric-powered mobile body having a remaining amount of power that is determined to decrease below the predetermined threshold.

5. The information processing method according to claim 1, wherein
the charging plan includes suppressing the battery degradation.

6. The information processing method according to claim 1, further comprising:
outputting the tightened constraint.

7. An information processing system, comprising:
a delivery plan creator that creates a delivery plan for packages to be delivered by a plurality of electric-powered mobile bodies, based on a constraint on travel for each of the plurality of electric-powered mobile bodies;
a power consumption calculator that calculates power consumption of each of the plurality of electric-powered mobile bodies based on the delivery plan;
a charge amount calculator that calculates a charge amount of each of the plurality of electric-powered mobile bodies from the power consumption and a remaining amount of power;
a charging plan creator that creates a charging plan for the plurality of electric-powered mobile bodies based on the charge amount of each of the plurality of electric-powered mobile bodies;
a determiner that determines whether charging of each of the plurality of electric-powered mobile bodies will finish by start of delivery, based on the delivery plan and the charging plan;
an outputter that outputs the delivery plan created; and
a constraint calculator that:
obtains a degree of battery degradation of each of the plurality of electric-powered mobile bodies;
calculates a usable amount of power for each of the plurality of electric-powered mobile bodies based on a battery charge amount that falls within a range of a predetermined degree of degradation acceleration obtained from the degree of battery degradation; and
calculates the constraint for each of the plurality of electric-powered mobile bodies based on the usable amount of power, wherein
the delivery plan creator recreates the delivery plan based on a tightened constraint that is obtained by tightening the constraint for an electric-powered mobile body whose charging is determined not to finish by the start of delivery.
